(19) United States
(12) Patent Application Publication
(10) Pub. No.: US 2007/0001591 A1
(43) Pub. Date: Jan. 4, 2007

(54) Organic electroluminescence display and manufacturing method thereof

(76) Inventor: Jun Tanaka, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/476,729

(22) Filed: Jun. 29, 2006

(30) Foreign Application Priority Data
Jun. 29, 2005 (JP) 2005-189228

(51) Int. Cl. H01J 1/62; H01J 63/04

(52) U.S. Cl. 313/504

(57) ABSTRACT

An organic electroluminescence display device of the invention includes a display circuitry substrate where a plurality of pixels (display circuits) each having an organic electroluminescence layer interposed between a pair of electrodes, and a planar sealing substrate bonded by a sealing material to the principal surface of the display circuitry substrate, in which a porous moisture adsorption film comprising a silicon dioxide particle condensation material is formed to the planar sealing substrate on the surface opposed to the principal surface of the display circuitry substrate, the moisture absorption film capable of outstandingly suppressing deterioration of the organic electroluminescence layer with moisture that is still formed even after sealing by the sealing material between the display circuitry substrate and the planar sealing substrate to attain a highly reliable organic electroluminescence display device at a reduced cost.

The present application claims priority from Japanese application JP 2005-189228 filed on Jun. 29, 2005, the content of which is hereby incorporated by reference into this application.

### BACKGROUND OF THE INVENTION

1. Field of the Invention

The present invention concerns an organic electroluminescence display device and, particularly, it relates to an organic electroluminescence device of high reliability improved for the problem of deterioration due to the effect of moisture content, by combination of a planar sealing substrate and a moisture adsorption film using, as a hygroscopic material, a porous film comprising a silicon dioxide particle condensation material adsorbing moisture physically.

2. Description of the Related Art

In an organic electroluminescence (hereinafter also referred to as “organic EL”) display device, since individual pixels are self-luminous different from a liquid crystal display device requiring back light, the organic EL is reduced in the thickness has wide view angle and is also excellent for dynamic image display because of high response speed to image signals compared with the liquid crystal device. Organic EL display devices having such characteristics have been vigorously studied and developed, and productization thereof has been announced extensibly in recent years.

Recently, the organic electroluminescence element (or, the organic electroluminescent element) is often described and/or referred as the organic light emitting diode (abbreviated as the OLED). Therefore, the organic electroluminescence (organic EL) display device referred in the following descriptions can be replaced by the known organic light emitting diode display device (abbreviated as the OLED display device).

An organic EL display device basically has a sandwich structure having an organic EL emission layer interposed between two electrodes (a pair of electrodes), in which current is supplied between the electrodes to emit light from the organic EL emission layer. Accordingly, in the organic EL display device, it is necessary that the electrode on the side of externally taking out a light from the organic EL emission layer and the substrate of the organic EL display device are transparent.

Each of pixels of an active type organic EL display device is provided with a pixel circuit including the organic EL emission layer and an active element for controlling the charge injection to the organic EL emission layer (typically represented by a thin film transistor). The active type organic EL display device is classified into a bottom emission structure adapted to take out a light from an organic EL emission layer provided to each pixel through a transparent substrate formed with the pixel circuit to the outside (user side) thereof, and a top emission structure adapted to take the light on the side opposite to the transparent substrate. In the active type organic EL display device having the top emission structure, since the factor that determines the efficiency of taking out the light from the organic EL emission layer of each pixel, that is, “pixel opening rate” is not restricted by the pixel circuit provided to the pixel, the brightness of the display images is increased. In the active type organic EL display device having the top emission structure, it is not necessary to form a substrate in which the pixel circuits are formed with a transparent material.

In the active type organic EL display device having the bottom emission structure, at least one of the pair of electrodes sandwiching the organic EL emission layer that situates on the side of the substrate where the pixel circuits are formed is formed as a transparent electrode. In the active type organic EL device having the top emission structure, at least one of the pair of electrodes that situates on the side opposite to the substrate where the pixel circuits are formed is formed as a transparent electrode. As a material for forming the transparent electrode, indium tin oxide material and indium zinc oxide material which are used also for the pixel electrode, for example, of liquid crystal display device have been known.

In the organic EL display device, the organic EL material is degraded due to the effect of moisture to cause display failure, for example, called as an edge growth in which emission is eliminated in the periphery of individual pixel patterns or a dark spot in which emission is eliminated in the image plane (display circuit region where a plurality of pixels are arranged). As means for suppressing the occurrence of such display failure, an air tight sealing structure of sealing a display circuit region where an organic EL layer (emission layer or the emission layer and other organic material layer laminated thereon) is formed together with a hygroscopic agent adsorbing moisture in a dry nitrogen atmosphere has been known. The air tight sealing structure is generally constituted by bonding the periphery of an organic electroluminescent display circuitry substrate by way of a sealing material (adhesive material) to a sealing substrate in order to shield a space in which the display circuit region and the hygroscopic material are shielded from the outer circumstance of the space. That is, a region where a plurality of pixels each including the organic EL layer are arranged (the display circuit region) is surrounded with the sealing material on the main surface of the organic EL display circuitry substrate.

For the airtight sealing structure, a film-shaped hygroscopic agent incorporating a chemical adsorbent that adsorbs moisture by way of chemical reaction of barium or calcium oxide as a hygroscopic agent is used. It has been known a technique of constituting the air tight sealing structure by using a sealing substrate formed of metal or glass having an excavated structure in s principal surface thereof, bonding the film hygroscopic agent to the inner surface of the excavated portion to air tightly seal the display circuit region (a plurality of organic EL layers) together with the hydroscopic agent in a dry nitrogen atmosphere (refer to Japanese Unexamined Patent Publication No. 9-148066). The thickness of the film hygroscopic agent is controlled such that it is not in contact with the surface of an organic EL substrate when bonded to the excavated portion and sealed between the organic EL display circuitry substrate and the sealing substrate.

A technique of using a material absorbing moisture physically as the adsorbent has also been known (refer to Y. Chang, et al., society for Information Display 2001 International Symposium Digest of Technical Papers, vol. XXXII, p1041 (2001)).

Further, it has been known a thin film solid sealing technique of forming a silicon nitride film not permeating moisture over an entire display circuit region where organic EL layers are formed without using the hygroscopic agent or the sealing substrate and coating the entire area of the display circuit region with the silicon nitride film, thereby solving the problem of the display failure due to the moisture effect described above (refer to T. Sasaoka, et al., society for Information Display 2001 International Symposium Digest of Technical Papers, vol. XXXII, p384 (2001)).

### SUMMARY OF THE INVENTION

Application of the background art described above to the organic EL display device involves the following problems. First, in the technique described in JP-A No. 9-148056, it is necessary to form an excavated portion where the film hygroscopic material is bonded to a metal or glass sealing substrate. However, a sealing substrate having such an excavated shape and capable of air tightly sealing the display circuit region and the hygroscopic material in a dry nitrogen atmosphere is not inexpensive.

Further, it needs an operation of bonding a film hygroscopic agent incorporating a chemical adsorbing hygroscopic agent to the excavated portion of the sealing substrate. In the operation, while a package of the chemical is opened adsorbent in a state sealed from the external circumstance, the chemical adsorbent reacts with moisture in the external circumstance just after the depacking to start adsorption. Accordingly, it is essential to keep the operation circumstance in an inert dry atmosphere state and this makes the handling of the chemical adsorbent extremely difficult.

In the thin film solid sealing technique described in International symposium Digest pf Technical Papers above, a silicon nitride film not permeating the moisture is formed as a passivation film over the entire display circuit region (also referred to as display region or pixel region), or a solid substrate is bonded by way of a buffer layer to a display circuitry substrate, thereby preventing moisture permeation in the passivation film or the buffer layer to prevent deterioration of the organic EL layer. The passivation film such as the silicon nitride film is formed generally by using a physical vapor deposition method of depositing atoms by a sputtering method to form a film, or a chemical vapor deposition method of forming plasmas from a starting material containing gas and depositing a radicalized starting material on a substrate to form a film.

However, when an inorganic film is formed over an upper electrode of an organic EL layer under a particle atmosphere at such high energy, it results in a problem that the organic EL layer is heated to be degraded by the atmospheric temperature, or the organic EL layer is deteriorated by high energy light radiated from the plasmas. In order to cope with the problem, it has been attempted to lower the film forming temperature for the passivation film. However, an inorganic film formed at a low temperature is poor in the quality and, for example, minute defects such as pinholes are formed in the inorganic film through which moisture intrudes to the display circuit region (sealing space) to deteriorate the organic EL layer. Accordingly, it has been demanded to stably form a passivation film under the condition of thoroughly excluding both of the effect due to the formation of the passivation film to the organic EL film and the effect due to the defects of the passivation film.

The present invention intends to overcome the various problems in the background art described above and provide an organic EL display device with suppressed deterioration of the display function due to the effect of moisture, having high reliability and capable of being manufactured at a reduced cost, by combination of “planar sealing substrate” and “porous moisture adsorption film comprising a silicon dioxide particle condensation material absorbing moisture physically”.

In an organic EL display device, an organic EL display circuitry substrate and a sealing substrate comprising a planar plate (planar sealing substrate) are bonded by using a sealing material to form a sealing structure where the organic EL display circuit is sealed from the external circumstance. In the planar sealing substrate, a porous moisture adsorption film comprising a silicon dioxide particle condensation material is formed on the side opposed to the organic EL display circuitry substrate (hereinafter also referred to as organic EL circuitry substrate, self-luminous display circuitry substrate or, simply, as display circuitry substrate). The porous moisture adsorption film of the silicon dioxide particle condensation material is formed, for example, over the entire principal surface of the planar sealing substrate including the outer circumference of the sealing portion. The thus formed porous film may not necessarily be patterned such that it is present only at specific positions on the principal surface. By saving the patterning for the porous moisture adsorption film, surplus manufacturing cost can be decreased. Alternatively, the porous moisture adsorption film comprising the silicon dioxide particle condensation material formed on the principal surface of the planar sealing substrate may be patterned such that it is present only at the inner specific position surrounded by the sealing material. The pattern for the porous moisture adsorption film is formed, for example, by the step of coating a colloidal silica material as a precursor thereof to the principal surface of the planar sealing substrate, then spraying an alcoholic solvent to the coating of the colloidal silica material and sucking to recover, under removing, the coating film of the colloidal silica material together with the solvent from the periphery of the principal surface of the substrate.

In a case where the particle size of the silicon dioxide particle (silica) is within a range of 2 nm or more and 500 nm or less, since the surface area of pore formed in the porous moisture adsorption film comprising the condensation material thereof increases to promote physical adsorption of moisture in the pore, the adsorbing performance of the moisture adsorption film is improved. Further, the light transmittance and the transparency of the moisture adsorption film can be improved by the use of the porous film formed as the silicon oxide particle condensation material having the particle size within the range described above.

By forming the porous moisture adsorption film comprising the silicon dioxide particle condensation material having transparency to the planar sealing substrate, transparency required as the characteristic of the planar sealing substrate can be ensured in an organic EL display device of the top emission structure of emitting light on the side opposite to the organic EL display circuitry substrate.

In a case where the particle size of the silicon dioxide particle (also referred to as silica material) forming the porous moisture adsorption film is 500 nm or more, a light transmitting the moisture adsorption film is scattered to deteriorate the optical characteristic in the organic EL display device of the top emission structure. Further, formation of the moisture adsorption film by agglomerating silicon dioxide particles with the particle size of the less then 2 nm is not practical in view of the physical limit in the technique of manufacturing the organic EL display device.

Silicon dioxide particle (silica particle) forming the porous moisture adsorption film according to the invention has siloxane bonds and silanol groups on the surface thereof. The siloxane bond portion (Si—O—Si) and the silanol group (Si—OH) interact with molecule of water to adsorb water molecule. In the invention, the moisture adsorption film has a porous structure formed by aggregating silicon dioxide particles having fine particle size to each other and physically adsorbs the molecules of water by intermolecular interaction caused between the porous structure and the molecules of water. The silicon dioxide particles each having a particle size less than 1 μm aggregate together so strongly that each pair thereof adjacent to each other are in contact with each other to form “the aforementioned condensation material thereof”. “The condensation material” has a porous structure in which each of pores is formed between respective one of the pairs of silicon dioxide particles, and each of the pores becomes a moisture absorbing site of the condensation material. It is estimated that due to the state of electrons on the surface of the silicon dioxide particles having such strong condensation force, oxygen atom in the siloxane bond or the silanol group reacts strongly to the hydrogen atom of the molecule of water to form a hydrogen bond or a bond similar therewith. Accordingly, in the moisture adsorption film according to the invention, molecules of water adsorbed to “the condensation material” contained therein are less dissociated compared with other hygroscopic agents physically adsorbing moisture. The pore in the porous moisture adsorption film (moisture adsorption site) according to the invention is formed such that the maximum value of the gap between each of the plurality of silicon dioxide particles is larger than the radius of the molecule of water (0.14 nm). In a case where the maximum value is 2 nm or more, the adsorption efficiency for the molecule of water by the moisture adsorption film is improved outstandingly.

The porous moisture adsorption film may be formed not only by condensation of silicon dioxide particles (silica particles as inorganic particles) but also by condensation of hybridization of the silicon dioxide particle with an organic polymer. The coatability and the depositability of the moisture adsorption film to the sealing substrate can be improved by using a condensation film formed by hybridization of the silicon dioxide particle and the organic polymer. The hybridization is facilitated by interaction of the silanol group of the silicon dioxide particle and the organic polymer to form the bond.

In the organic EL display device assembled by bonding the organic EL display circuitry substrate and the planar sealing substrate and sealing a space between them, the volume of space air tightly sealed space can be decreased to less than that of the organic EL display device using a sealing substrate having an excavated shape instead of the planar sealing substrate. Since the moisture content that can be present in the space is in proportion with the volume thereof, the amount of steams saturated in the space can be decreased in the organic El display device using the planar sealing substrate compared with the organic EL display device using the excavated sealing substrate. It is considered that moisture dissociated from the sealing material or moisture permeating the sealing material from the outside of the sealing space is present in the space sealed by the organic EL display circuitry substrate, the planar sealing substrate, and sealing material bonding them to each other (hereinafter referred to as sealing space). Accordingly, by decreasing the height of the sealing material, that is, narrowing the gap between the substrates, it is possible to decrease the amount of the sealing material used for forming the sealing space or decrease the cross sectional area of the sealing material for permeating the moisture to decrease the amount of moisture intruding into the sealing space. The effect described above becomes conspicuous by using a hygroscopic agent physically adsorbing moisture as the porous film comprising the silicon dioxide particle condensation material having less moisture adsorbing effect compared with a moisture adsorbent of adsorbing moisture by chemical reaction such as calcium oxide. The molecular structure of the hygroscopic agent of physically adsorbing moisture is more stable compared with the molecular structure of the hygroscopic agent chemically adsorbing moisture. By disposing the porous film comprising the silicon dioxide particle condensation material as a hygroscopic agent in a sealing space, release of moisture from the hygroscopic agent per se to the sealing space is suppressed. Further, it is estimated that the porous film comprising the silicon dioxide particle condensation material can easily maintain the moisture adsorption state due to the electron state thereof. Accordingly, the porous film disposed in the sealing space less detaches the moisture adsorbed in the sealing space. Further, even when the porous film is extended from the sealing space to the outside thereof, it does not results in trouble for the fixing the sealing material to the sealing substrate and adsorbs moisture dissociating from the sealing material.

By controlling the height of the sealing material disposed at the periphery of each principal surface of the organic EL display circuitry substrate and the planar sealing substrate, it is possible to decrease the thickness (gap) between the outermost surface of the organic EL display circuitry substrate (uppermost surface of the structure formed on the principal surface of the organic EL display circuitry substrate) and the planar sealing substrate. Accordingly, in a case of the organic EL display device of the top emission structure, by decreasing the thickness amount (clearance of the gap) from the outermost surface of the organic EL display circuitry substrate to the rear face of the sealing substrate, compared with an interval of the pixels, color mixing observed at the rear face of the sealing substrate (another principal surface on the side opposite to the sealing space) is decreased when light emission from each of the pixels is emitted from the rear face of the sealing substrate.

The porous moisture absorption film comprising the silicon dioxide condensation material is formed by coating and heating a solution of silicon dioxide particles dispersed in a colloidal state in an alcohol solvent or ketone solvent to the principal surface of a sealing substrate. Sometimes the silicon dioxide particle present in the colloidal state in the solution is referred to as colloidal silica, and the solution in which the colloidal silica is dispersed is referred to as a colloidal silica solution, and a film using the same as a precursor is referred to as a colloidal silica film. As the alcohol solvent, methanol, ethanol, isopropyl alcohol, etc. are used and, as the ketone solvent, acetone, methyl ethyl ketone, methyl isobutyl ketone, etc. are used.

The solution is coated to the principal surface of the sealing substrate by using a method, for example, spin coating, slit coating or printing coating. Since the porous film of the silicon dioxide particle condensation material formed by the film forming method described above is a planar film of uniform thickness, light does not scatter at the unevenness on the surface of the porous film and the length of the transmission light channel is also uniform to be excellent in optical characteristics. Accordingly, the porous film is suitable for a moisture adsorption film formed at the sealing substrate of an organic EL display device having the top emission structure.

The condition of heating the coating of the colloidal solution of the silicon dioxide particle (the colloidal silica solution) is preferably 300° C. or lower. It is particularly preferred to increase the temperature of the coating stepwise. The colloidal film of the silicon dioxide particle is formed substantially uniformly, by controlling the heating temperature for the coating by increasing the temperature stepwise each by 40 to 60° C. on every 5 to 20 min, for example, by keeping the temperature at 100° C. for about 10 min, then keeping at 150° C. for about 10 min and, further, keeping at 200° C. for about 10 min, thereby evaporating volatile ingredients such as a solvent gradually from the coating. By the heating method for the coating as described above, deterioration of the uniformity of the colloidal film of the silicon dioxide particles due to the abrupt evaporation of the solvent from the coating can be suppressed.

The atmosphere of heating the coating of the colloidal solution of the silicon dioxide particles (colloidal silica solution) is preferably kept as a circumstance filled with an inert gas such as nitrogen but it is not restricted to specific conditions. Since the colloidal film of the silicon dioxide particles physically adsorbs the moisture, administration of the atmosphere during film formation is simpler and convenience compared with the film forming atmosphere for the hygroscopic material chemically adsorbing moisture (chemically adsorbing type hygroscopic material). Since the chemically adsorbing type hygroscopic material chemically reacts with molecules of water and adsorbs them, film formation has to be conducted in an extremely dry atmosphere.

The sealing substrate formed as the hygroscopic material from the porous film comprising the silicon dioxide particle condensation material is preferably heated in a dry atmosphere under the condition, for example, at 150° C. or higher and 300° C. or lower to apply dewatering treatment to the porous film (hygroscopic material). By the dewatering treatment, the moisture adsorbing performance of the porous film formed on the principal surface of the sealing substrate is initialized just before bonding of the sealing substrate to the organic EL display circuitry substrate, and the porous film is tightly sealed in a sealing space between the EL display circuitry substrate and the sealing substrate in a state where the adsorption force of the porous film is highest.

Since the porous film comprising the silicon dioxide particle condensation material can be formed by coating the colloidal solution thereof to the principal surface of the sealing substrate and it is transparent, it can be used as an overcoat film for coating the entire color filter layer in an organic EL display device of the top emission structure formed by bonding an organic EL display circuitry substrate where organic EL films (organic EL display circuit) emitting white light are formed on every pixels, and a sealing substrate where color filter layers of red, blue, and green colors are formed in accordance with the pixels. When the porous film is used as the overcoat film for the color filter layer, since the porous film is present at the uppermost surface opposing to the organic EL display circuitry substrate on the principal surface of the sealing substrate, the sealing space can be sealed tightly in a state where the moisture adsorption performance thereof is provided most effectively.

In the preparation of the sealing substrate having the porous film comprising the silicon dioxide particle condensate material as the overcoat film for the color filter layer, pigment dispersed color filter resist materials if primary colors are at first coated successively on the principal surface thereof, and each of them is formed into red, blue, and green pixel patterns respectively by using a well-known photolithography. The overcoat film is formed by coating a colloidal solution of silicon dioxide particles (colloidal silica solution) over the thus formed color filter layer comprising a plurality of patterns of colors different from each other and heating the same. The film forming temperature for the overcoat film (heating temperature for the coating of the colloidal solution) is preferably increased stepwise finally to 200° C. or higher for the removal of moisture incorporated in the color filter layer. Since there may be a problem that the color filter layer is deteriorated to discolor by the temperature in this step, the final heating temperature for the overcoat film is preferably lower than the deterioration temperature of the color filter layer.

Further, also in the dewatering treatment of the porous film comprising the silicon dioxide particle condensation material formed as the overcoat film for the color filter layer, it is desirable to heat the sealing substrate at a temperature preventing the deterioration of the color filter layer and it is desirable for a heat treatment at 250° C. or lower for a sealing substrate where usual pigment-dispersed color filter is formed.

The porous film comprising silica particles as the main ingredient may also be patterned. After forming the porous film comprising the silicon dioxide particle condensation material on the principal surface of the sealing substrate, a resist film is formed on the porous film and the resist film is patterned by photoexposure development using usual photolithography. The porous film of the silicon dioxide condensation material is wet-etched or dry-etched to remove unnecessary portion thereof using the patterned resist as a mask. Then, the pattern of the porous film is formed by removing the resist.

For the wet etching of the porous film (moisture adsorption film), a chemical solution capable of etching the etching silicon dioxide, for example, hydrofluoric acid may be used preferably. Further, for dry etching of the porous film, formed by mixing a gas capable of etching silicon dioxide, for example, a perfluoro carbon reactant gas such as CF₄ or a hydrofluoro carbon reactant gas such as CH₂F₂, and a rare gas such as He or Ar may be preferably used.

In the passive type organic EL display device, pillars formed by patterning the porous film of silicon dioxide condensation material may be formed as partition walls between adjacent pixels (organic EL layers) on the principal surface of the organic EL display circuitry substrate. Since the pillars per se have a function of the moisture absorption film, an organic EL display device with the effect of moisture to the organic EL layer being further decreased and having higher reliability compared with existent passive type organic EL display device can be attained.

As described above, an organic EL display device with suppressed deterioration of the organic EL layer due to the effect of moisture, having higher reliability and capable of being manufactured at a reduced cost can be attained by the combination of a planar sealing substrate and a porous moisture absorption film comprising silicon dioxide particle condensation material physically adsorbing moisture.

### BRIEF DESCRIPTION OF THE DRAWINGS

FIG. 1 is a cross sectional view for explaining an optional EL display device of a bottom emission structure to which the invention is applied;

FIG. 2 is a cross sectional view for explaining an optional EL display device of a top emission structure to which the invention is applied;

FIG. 3 is a cross sectional view for explaining an organic EL device of a double-sided light emitting structure to which the invention is applied;

FIG. 4 is a cross sectional view for explaining an organic EL device of a top emission structure having a color filter layer to which the invention is applied;

FIG. 5 is a cross sectional view for explaining a passive type optional EL display device of a bottom emission structure to which the invention is applied;

FIG. 6 is a cross sectional view of an organic EL display device for explaining Comparative Example 1 in the invention;

FIG. 7 is a cross sectional view of an organic EL display device for explaining Example 28 in the invention;

FIG. 8 is a cross sectional view showing an example of a pixel of an active type organic EL display device; and

FIG. 9 is a cross sectional view showing an example of an equivalent circuit of an active type organic EL display device.

### DETAILED DESCRIPTION OF THE PREFERRED EMBODIMENT

The present invention is to be described specifically by way of preferred embodiments with reference to the drawings. Since, an organic electroluminescence element (or, an organic electroluminescent element, both abbreviated as an organic EL element) is described as the organic light emitting diode (abbreviated as the OLED), the present invention explained hereinafter will be applicable to any kind of organic light emitting diode display devices (abbreviated as the OLED display device) even lately released as well as the organic electroluminescence display devices (the organic EL display devices) referred in the following explanations.

At first, configuration examples of organic EL display device for practicing the invention and application of the invention to each of the configuration examples (combination of “planar sealing substrate” and “porous film comprising a silicon dioxide particle condensation material”) to each of the configuration examples are to be described.

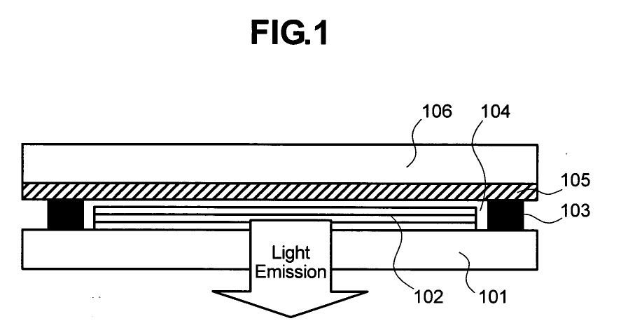

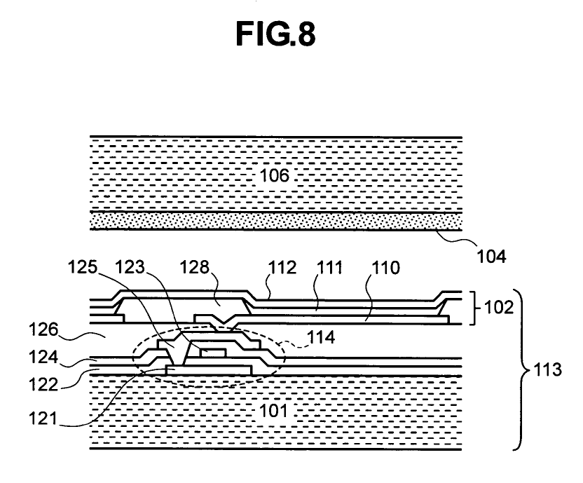

FIG. 1 is a cross sectional view for conceptionally explaining an organic EL display device of a bottom emission structure to which the invention is applied. In FIG. 1, a pair of electrodes and an organic EL layer interposed therebetween are illustrated as a lamination structure referred as an organic EL display circuit 102. An example for the cross section of a pixel in the organic display device shown in FIG. 1 is specifically shown in FIG. 8. The organic EL display device includes, on a main surface of a transparent substrate 101, an organic EL display circuitry substrate (reference numeral 113 in FIG. 8) in which an organic EL display circuit 102 is formed by laminating a light transmitting lower electrode (reference numeral 110 in FIG. 8), an organic EL layer (reference numeral 111 in FIG. 8), and a not transparent upper electrode for reflecting light emission of the organic EL layer (reference numeral 112 in FIG. 8) successively, and a planar sealing substrate 106 having a porous film comprising an silicon dioxide condensation material (moisture absorption film) 105 formed on the principal surface thereof. The organic EL display circuitry substrate 113 is defined in the following description as a component including a substrate (transparent substrate 101 in FIG. 1) and a structure formed on the principal surface thereof, and the cross sectional structure is different depending on the driving system for the organic EL display device as to be described subsequently.

The organic EL display circuitry substrate and the planar sealing substrate 106 are bonded to each other by using a sealing material 103 for use in inter-substrate sealing to seal a space 104 between both of the substrates. In the space 104, the organic EL display circuit 102 is air tightly sealed together with the porous film (moisture absorption film) 105. Further, in a case where the organic EL display circuitry substrate (reference numeral 113 in FIG. 8) and the planar sealing substrate 106 are bonded to each other in a dry nitrogen atmosphere, the space 104 is substantially filled with dry nitrogen. A light generated in the organic EL layer (reference numeral 111 in FIG. 8) is passed through the light transmitting lower electrode (reference numeral 110 in FIG. 8) and is taken to the outside of the organic EL display device from the side of the transparent substrate 101 as the substrate for the organic EL display circuitry substrate. An organic EL display device adapted to take out a light on the side of the substrate formed with the organic EL display circuit 102 (substrate) and display images is referred to as an organic display device of a bottom emission structure. In the structure, the planar sealing substrate 106 may be transparent or not transparent.

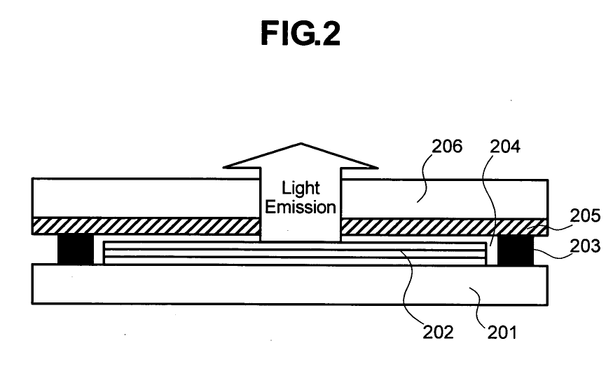

FIG. 2 is a cross sectional view for explaining an organic EL display device of a top emission structure to which the invention is applied. Also in FIG. 2, an organic EL layer and a pair of electrodes between which the organic EL layer is disposed are illustrated as a lamination structure referred to as an organic EL display circuit 202 and an example of the pixel cross section is to be described specifically with reference to FIG. 8. The organic EL display device intrudes, on a principal surface of a substrate 201, an organic EL display circuitry substrate (for example, reference numeral 113 in FIG. 8) where an organic EL display circuit 202 is formed by laminating a lower electrode reflecting light emission of the organic EL layer (for example, reference numeral 110 in FIG. 8) for reflecting light emission of the organic EL layer, an organic EL layer (for example, reference numeral 111 in FIG. 8) and a light transmitting upper electrode (for examples, reference numeral 112 in FIG. 8) successively (for example, reference numeral 113 in FIG. 8), and a transparent planar sealing substrate 206. An organic EL display device of a top emission structure for taking out light emission on the side of the planar sealing substrate 206 is obtained by bonding the organic EL display circuitry substrate using a sealing material 203 for inter-substrate sealing to the principal surface of the planar sealing substrate 206 formed with a porous film comprising a silicon dioxide particle condensate material (moisture absorption film) 205 and sealing a space 204 between both of the substrates.

The organic EL display circuit 202 is air tightly sealed together with the porous film (moisture absorption film) 205 in the space 204 and is filed substantially with dry nitrogen by bonding the organic EL display circuitry substrate (for example, reference numeral 113 in FIG. 8) and the planar sealing substrate 106 in a dry nitrogen atmosphere. As shown in FIG. 2, an organic EL display device adapted to take out a light on the side opposite to the substrate formed with the organic EL display circuit 202 (on the side of planar sealing substrate 106 in FIG. 2) and displays images is referred to as an organic EL display device of top emission structure. In the structure, the substrate 201 may be transparent or not transparent.

Each of a plurality of pixels arranged in a 2-dimensional manner in the display circuit region of the organic El display device (display region) basically has a cross sectional structure illustrated in FIG. 8 irrespective that the organic EL display device has a bottom emission structure or a top emission structure. The organic El display device is classified into a group driven by an active matrix system and a group driven by passive matrix system. The pixel having the cross sectional structure shown in FIG. 8 is disposed to the organic display device belonging to the former group and have an active element 114 (thin film transistor) on every pixel.

The cross sectional structure shown in FIG. 8 is to be described for an example of the organic EL display device of a bottom emission structure shown in FIG. 1. On the principal surface of the substrate 101 made of a dielectric material such as quartz or non-alkali glass, are formed a semiconductor layer 121 as a channel (active region) of an active element 114, a first dielectric film (gate dielectric film) 122 covering a semiconductor layer 121, a control electrode (gate electrode) 123 opposing to the semiconductor layer 121 by way of the first dielectric film 122, a second dielectric film 124 covering the first dielectric film 122 and the control electrode 123 (inter-layer dielectric film) 124, and an output electrode (drain electrode) 125 disposed above the second dielectric film 124 and electrically connected with one end of the semiconductor layer (channel) 121 through a through hole penetrating the first dielectric film 122 and the second dielectric film 124 in this order.

The active element 114 supplies current through the channel 121 and the output electrode 125 between a pair of electrodes (between a lower electrode 110 and an upper electrode 112) of the organic EL display circuit to emit light from an organic EL layer 111. Current supply by the active element 114 to the organic EL display circuit is controlled by an electric field applied from the control electrode 123 to the channel 121.

A leveling layer 126 made of a dielectric material covering the second dielectric film 124 and the output electrode 125 is formed on the principal surface of the substrate 101 and then the lower electrode (also referred to as a first electrode) 110 for the organic EL display circuit (single organic EL device) 102 is further formed of a conductive material. A first electrode 127 is in contact with the output electrode 125 of the active element 114 through a through hole penetrating the leveling layer 126 and receives a current for emitting light from the organic EL layer 111. A dielectric partition wall 128 formed over the leveling layer 126 so as to surround the first electrode 127 and also referred to as a bank electrically separates the organic EL display circuit 102 (lower electrode 110 and organic EL layer 111) formed respectively to adjacent pixels. The organic EL layer 111 is formed by supplying an organic material to the exposed surface of the lower electrode 110 surrounded with the dielectric partition wall 128 at the circumferential edge thereof. Supply of the organic material to the lower electrode 110 is conducted by vapor deposition of an organic material referred to as a low molecular type material, printing of an organic material referred to as high molecular type material or ink jetting of the solution thereof. Different from the lower electrode 110 and the organic EL layer 111, the upper electrode (also referred to as second electrode) 112 of the organic EL display circuit 102 formed over the organic EL layer 111 (also referred to as a second electrode) 112 is formed overriding the adjacent pixels adjacent with each other. The organic EL layer 111 may be constituted not only with the light emission layer but also by laminating other organic material layer therewith. The organic EL layer 111 is formed, for example, by laminating a hole transport layer, a light emission layer, and an electron transport layer in this order above the lower electrode 110. In a case where at least one of the lower electrode 110 and the upper electrode 112 is formed as a laminate structure comprising a plurality of conductive material layers, ohmic contact thereof with the organic EL layer 111 or the output electrode 125 and the reflectivity of light from the organic EL layer 111 can be improved.

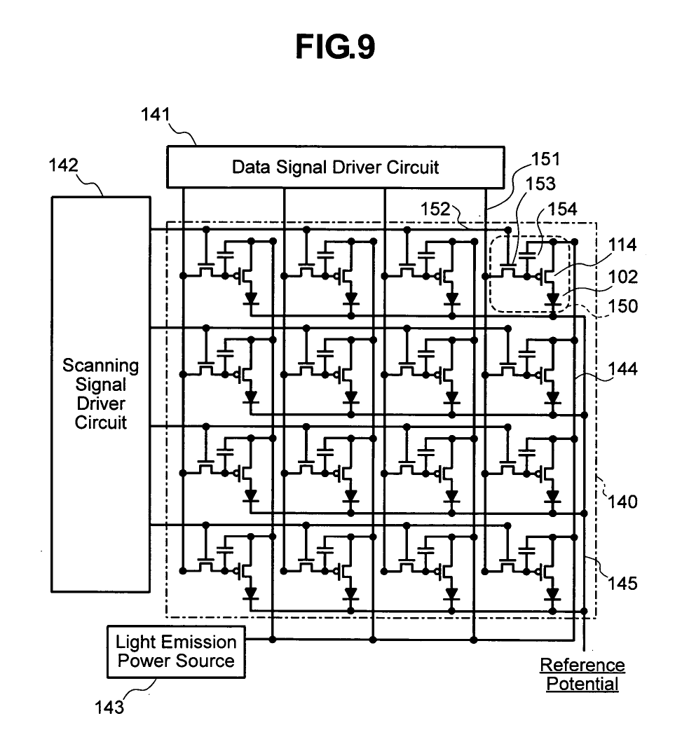

On the other hand, FIG. 9 shows the outline of a display circuit of an organic EL display device driven by an active matrix system (hereinafter referred to as an active type organic EL display device). An organic EL display circuit (single organic EL element) 102 disposed to each of the pixels 150 is shown as a diode. On the principal surface of the substrate 101 described above, a plurality of pixels 150 each illustrated by a region surrounded with a dotted chain are arranged in a 2-dimensional manner to constitute a display circuit region (also referred to as a display region or pixel array) 140. The entire display circuit region displays images as an image plane of the organic EL display device. The light emission operation of the organic EL display circuit 102 in each of the individual pixels 150 is controlled by one of a plurality of data lines 151 extending in the longitudinal direction and arranged in parallel along the lateral direction (crossing the longitudinal direction), and one of a plurality of scanning lines 152 extending in the lateral direction and arranged in parallel along the longitudinal direction in FIG. 9. Image data displayed by the display circuit region 140 is outputted from a data signal driver circuit 141 to the data line 151, and the scanning line 152 receives the output from the scanning signal driver circuit 142 and controls acquisition of the image data in each of the pixels 150. On the other hand, current required for the light emission operation of the organic EL display circuit 102 is supplied from a light emission power source 143 through a current supply line 144 to each of the pixels 150 and the current passing the organic EL display circuit 102 flows out to a reference potential line (for example, ground potential line) 145. Supply of the current from the light emission power source 143 to the organic EL display circuit 102 of each of the pixels 150 is controlled by the active element 114 described with reference to FIG. 8.

Each of the pixels 150 has an active element 153 different from the active element 114 which obtains the image data from the data line 151 corresponding to the scanning signal from the scanning line 152. The image data is stored, for example, as a voltage signal through the active element 153 to a capacitor 154 disposed to each of the pixels 150. An electric field applied from the control electrode 123 of the active element 114 to the channel 121 thereof is determined depending on the voltage signal accumulated in the signal capacitor 154 and keeps the light emission from the organic EL display circuit 102 in each of the pixels 150 at a desired brightness over a predetermined period (referred to as a frame).

On the other hand, it may be explained that the display circuit of the organic EL display device driven by a passive matrix (hereinafter referred to as a passive type organic EL display device) can be constituted by having the data line 151 connected to one end of the organic EL display circuit 102 and the scanning line 152 connected to the other end of it in FIG. 9 respectively. That is, in the passive type organic EL display device, it is no more necessary to provide the active elements 114, 153 and the capacitor 154 described above on every pixels 150. Also the first dielectric film 122, the second dielectric film 124, and the leveling layer 125 shown in FIG. 8 are not basically necessary. Further, the lower electrode 110 may be extended as the data line 151 (or scanning line 152) and the upper electrode 112 may be extended as the scanning line 152 (or data line 151), respectively, in FIG. 8. However, one of the data signal driver circuit 141 or the scanning signal driver circuit 142 is required to have a function of the light emission power source (supply of current required for light emission operation) and the light emission term on every frame term in each of the pixels 150 is also restricted.

The transparent member described above is allowed to absorb a light in a visible region transmitting therethrough within a range not hindering the image display by the organic EL display device and it may suffice that the material shows a transmittance of 70% or higher relative to a light incident thereto. In the passive type organic EL display device or active type organic EL device of the top emission structure, since the area for taking out the light emission from the organic EL layer to the outside is not restricted by the active elements 114, 153, the opening rate of the pixel 150 is increased and the display brightness of the images can be increased easily.

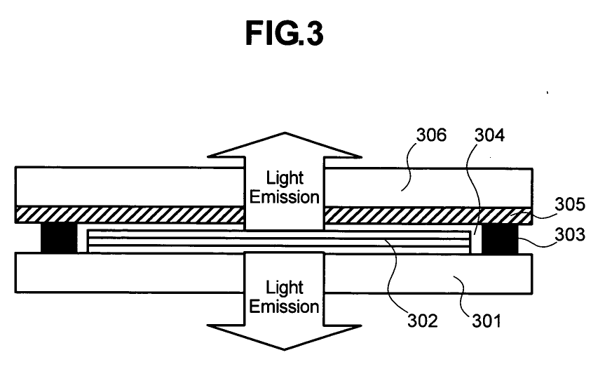

FIG. 3 is a cross sectional view for explaining an organic EL display device of a double-sided light emission structure to which the invention is applied. The organic EL display device includes an organic EL display circuitry substrate where an organic EL display circuit 302 is formed by laminating a light transmitting lower electrode (not illustrated), an organic EL layer (not illustrated), and a light transmitting upper electrode (not illustrated) successively, and a planar sealing substrate 306, on a principal surface of a transparent substrate 301. An example for the cross section of individual pixels disposed to the organic EL display device having the cross sectional structure shown in FIG. 3 is also described generally with reference to FIG. 8 specifically like the organic EL display device having the cross sectional structure shown in FIG. 1 or FIG. 2. An organic EL display device of a double-sided light emitting structure adapted to take out light emission on both surfaces of the organic EL display circuitry substrate and the planar sealing substrate 306 is obtained by bonding the organic EL display circuitry substrate and the transparent planar sealing substrate 306 where a transparent porous film comprising the silicon dioxide condensation material (moisture absorption film) 305 is formed on the principal surface to each other by using a sealing material 303 used for inter-substrate sealing and sealing a space 304 between both of the substrates.

In the organic EL layer display device in each of the configuration examples described above, the organic EL layer emits a light by generating current and voltage between both of upper and lower electrodes. Such an organic EL display circuit is in common with any of the passive type organic EL display circuits and an active type organic EL display circuit having a thin film transistor element on every pixel, and both of them can provide the same effect regarding the suppression of display failure due to the porous moisture absorption film described above.

Further, the organic EL display circuit for each of the configuration examples described above can display color images by the combination of respective pixels having organic EL layers of emission colors corresponding to red, blue and green colors.

In the organic EL display circuit in each of the configurational examples described above, by defining the particle size of the silicon dioxide particles forming the porous moisture adsorption film within a range of 2 nm or more and 500 nm or less, the surface area of the silicon dioxide particles (silica) in the porous moisture adsorption film formed as a condensation material thereof is increased to improve the moisture adsorption performance of the moisture adsorption film and improve the light transmittance (the translucency) and the transparency of the condensation material. Since the silicon dioxide particles having the particle size within the range described above have a strong condensation force, a pair of adjacent particles are them is in contact with each other and, further, form a dense condensation material so as to form “contact face” between them. A plurality of pores are formed in the “condensation material” as a space surrounded by the surface of a plurality of silicon dioxide particles in contact with each other to make the moisture adsorption film porous. It is one of the features of the moisture adsorption film according to the invention to utilize the space surrounded by a plurality of hygroscopic particles, contrary to zeolite and silica gel that utilizes “pores (porous structure)” of the hygroscopic particle per se. In the moisture adsorption film according to the invention, molecules of water intrude between a plurality of silicon dioxide particles and are adsorbed to one of the surfaces thereof in the space surrounded by them.

The hygroscopic effect due to the porous moisture absorption film is due to the interaction between oxygen atoms in the siloxane bond site (Si—O—Si) and the silanol group (Si—OH) present on the surface of the silicon dioxide particles (silica particles) forming the film and hydrogen atoms of the molecule of water. In a case where the particles size of the silicon dioxide particles is less than 1 μm, it is estimated that molecules of water attracted by the van der Waals force to the absorption site by the condensation force and corresponding electron state on the surface of the silicon dioxide particles form hydrogen bonds or bonds similar therewith between the hydrogen atoms thereof and oxygen atoms in the siloxane bond site or the silanol groups (Si—OH) on the surface of silicon dioxide particle. That is, contrary to the common knowledge that molecules of water physically adsorbed to the adsorption site are liable to be dissociated from the adsorption site, the molecules of water physically adsorbed to the moisture absorption film of the invention are less dissociated. For attaining the characteristic of the moisture absorption film according to the invention, it is recommended to optimize “pore” in the porous structure. For example, in a case where the maximum value of the “clearance” formed between a plurality of the silicon dioxide particles as the “pore” is made larger than the radius of the molecule of water (0.14 nm) and, further, the maximum value is 2 nm or more, the adsorption efficiency of the molecule of water by the moisture absorption film is improved outstandingly.

Further, the porous moisture absorption film according to the invention can provide the following advantages also when it is formed so as to extend from the “sealed space” surrounded with the organic EL display circuitry substrate, the sealing substrate and the sealing material to the out side as shown in FIG. 1 to FIG. 3. That is, moisture absorbed in the moisture absorption film outside the sealing space is not dissociated therefrom after being transported along the film to the inside of the sealing space. Further, since the moisture absorption film keeps to adsorb molecules of water generated upon hardening of the sealing material, it suppresses the release of moisture to the inside of the sealing space from the sealing material caused in the step of bonding the organic EL display circuitry substrate and the sealing substrate. Further, the moisture absorption film comprising silicon dioxide particles agglomerated densely does not impair the air tightness of the “sealing space” due to the sealing material even in contact with the sealing material on the side of the substrate. Such an advantage also shows that the moisture absorption film can be utilized by merely forming the film over the entire principal surface of the sealing substrate. In other words, it is no more necessary for the step of eliminating or removing a portion in contact with the sealing material or extending to the outside of the sealing space by the patterning of the moisture absorption film formed on the principal surface of the sealing substrate, and at least one of the manufacturing steps of the organic EL display device can be decreased. In a case of using a planar sealing substrate having a planar principal surface (not formed with concave or convex portion larger than the thickness of the moisture absorption film) formed with the moisture absorption film, the moisture absorption film formed on the principal surface no more requires a treatment for leveling the surface.

The porous moisture absorption film according to the invention is formed by using a solution in which silicon dioxide particles (silica particles) are dispersed in a colloidal state (colloidal silica solution) as a precursor, coating the solution on the principal surface of the sealing substrate and, further, evaporating the solvent (binder) of the solution from the coating film. As a method of coating the colloidal solution of silicon dioxide particle (colloidal silica solution) on the principal surface of the sealing substrate includes rotary coating, slit coating, or a printing method. The coating method is suitable particularly as a preferred and simple method of forming a colloidal film of silicon dioxide particle (colloidal silica film) over the entire area for the principal surface of the planar sealing substrate (hereinafter referred to as a planar sealing substrate) described above and the silicon dioxide particle condensation material is formed as a planar porous film of uniform thickness.

The particle size and the purity of the silicon dioxide particle used for the porous moisture absorption film according to the invention can be controlled in the colloidal solution thereof. For example, with view points of the condensation of silicon dioxide particle and the light transmittance (the translucency) of the porous moisture absorption film, colloidal solution is controlled for the presence of calcium (Ca), aluminum (Al), sodium (Na), potassium (K) as contained in zeolite such that the total of the remaining amount of them in the porous moisture absorption film is less than 1%. Further, in the colloidal solution, an alcohol solvent such as methanol, ethanol, or isopropyl alcohol, or a ketone solvent such as acetone, methyl ethyl ketone, or methyl isobutyl ketone is used as the dispersion medium of the colloid of the silicon dioxide particle is used, and it is also recommended to restrict the residual amount of the medium in the porous moisture absorption film in view of the agglomeration of the silicon dioxide particles. While the compositional ratio of the porous moisture absorption film is ideal as it approaches the stoichiometrical ratio of the silicon dioxide particle, it is preferred to control the total of the residual amount in the porous moisture absorption film of carbon (C), hydrogen (H), and nitrogen (N) which may be attributable mainly to the dispersion medium to less than 10%. However, since a portion of organic materials remaining in the porous moisture absorption film promotes agglomeration of the silicon dioxide particles, the residual amount may not be decreased as far as 0%. The porous moisture absorption film controlled for the quality as described above is formed as a so-called transparent film showing a transmittance to a light in a visible region (for example, a wavelength region from 380 nm to 770 nm) of at least 70% and, optimally, 80% or more.

In recent years, a technique of stacking large-sized glass substrate to each other and collectively obtaining a plurality of display panels in the production lines for liquid crystal display devices. It is also possible to use the same technique for the organic EL display device. In this case, since the entire sealing substrate has a uniform thickness in a case of using a planar sealing substrate where a porous film of the silicon dioxide particle condensation material is formed over the entire surface, a plurality of organic EL display devices (panels) can be collectively stacked to each other and sealed simply and conveniently compared with the case of using excavated sealing substrates having unevenness. Accordingly, since a plurality of organic EL display devices can be manufactured all at once, the cost can be decreased remarkably also for the manufacturing apparatus to provide a significant effect capable of suppressing the cost for the element required per one organic EL display device.

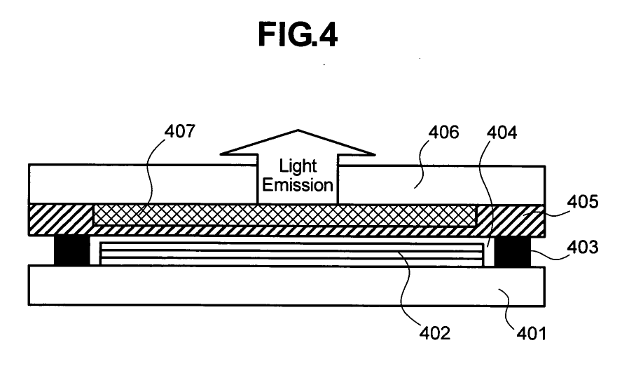

FIG. 4 is a cross sectional view for explaining an organic EL display device of a top emission structure having a color filter layer to which the invention is applied. The organic EL display device has a top emission structure having, formed on a principal surface of a planar sealing substrate, a plurality of color filter layers of three colors of red, blue and green light, or a plurality of colors corresponding to them that correspond to a plurality of pixels formed on the principal surface of the organic EL display circuitry substrate, and a porous film comprising the silicon dioxide particle condensation material (moisture absorption film) for covering the entire color filter layer.

In FIG. 4, the device has, on a substrate 401, a substrate having an organic EL display circuit 402 formed by laminating a lower electrode for reflecting light emission from an organic EL layer, the organic EL layer, and a light transmitting upper electrode in this order (organic EL display circuitry substrate) and a planar sealing substrate 406. The lamination structure of the organic EL display circuit 402 is substantially identical with the organic EL display circuit 102 in FIG. 8. The planar sealing substrate 406 has a transparency to light emission from the organic EL layer including the transparent porous film 405 of the silicon dioxide particle condensation material formed so as to cover the entire color filter layer 407. A space 404 between the an organic EL display circuitry substrate and the planar sealing substrate 406 is sealed by bonding both of the substrates using a sealing material 403 for inter-substrate sealing. Thus, an organic EL display device of a top emission structure for taking out light emission on the side of the planar sealing substrate 406 is obtained.

It is preferred that the organic EL layer disposed to each of the pixels of the organic EL display device shown in FIG. 4 comprises a material emitting a substantially identical color (for example white color), and the color filter layer 407 is formed as pixels corresponding to three colors of pigment-dispersed type red, blue and green colors. Then, when light emission (for example, white light) from the organic EL layer transmits the color filter layers, it is spectralized into three colors of red, blue, and green to obtain an organic EL display device capable of color image display.

The silicon dioxide particle condensation material porous film 405 is also an overcoat film covering the entire color filter layer 407 and since this is present at the uppermost surface opposing to the organic EL display circuitry substrate (surface nearest to the organic EL display circuitry substrate) on the principal surface of the planar sealing substrate 406, it can be sealed in the sealing space in a state where the moisture adsorption performance is most increased.

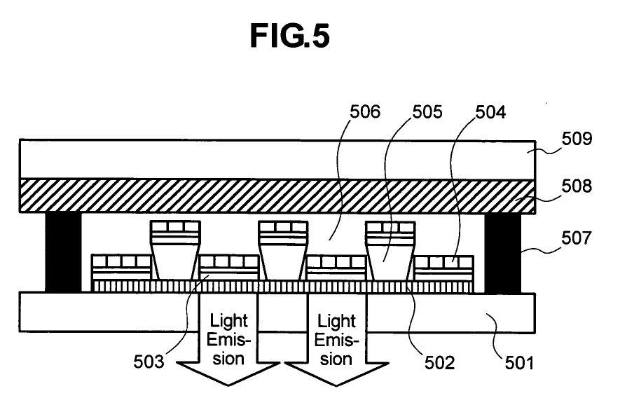

FIG. 5 is a cross sectional view for explaining a passive type organic EL display device of a bottom emission structure to which the invention is applied. The organic EL display device is a passive type organic type EL display device in which a porous moisture absorption film comprising the silicon dioxide particle condensation material is formed as a pixel partition wall upon forming an organic electroluminescence layer on the principal surface of an organic EL display circuitry substrate (substrate 501). The pixel partition wall can be said to correspond to the dielectric partition wall of the active type organic El display device shown in FIG. 8. In FIG. 5, a lower electrode 502 is formed at first above a substrate 501.

Then, a porous film of the silicon dioxide particle condensation material is formed on the principal surface of the substrate 501 and heated. A coating of a photoresist (not illustrate) is formed over the porous film and exposed and developed by using well-known photolithography to form into a desired resist pattern. The porous film is patterned using the resist pattern as a mask and the photoresist film is removed to obtain a porous pillar 505 of the silicon dioxide particle condensation material as a pixel partition wall.

Then, an organic EL layer 503 and an upper electrode 504 also as a reflection electrode are formed at the upper surface of the lower electrode 502 and the porous pillar 505. The organic EL layer 503 and the upper electrode 504 are isolated as a pattern on every pixels by the porous pillars 505.

Then, the substrate 501 is bonded to the principal surface of the planar sealing substrate 509 formed with a porous film (moisture absorption film) 508 comprising the silicon dioxide particle condensation material to each other by using a sealing material 507 for inter-substrate sealing, and a space 506 between both of the substrates is sealed, to obtain a passive type organic EL display device.

For the transparent lower electrode 502, an ITO (indium tin oxide) film or IZO (indium zinc oxide) film can be used. As the transparent upper electrode 504, an IZO film which is transparent formed even by low temperature film formation is suitable. As the upper electrode 504 as the reflection electrode, a aluminum film or chromium film can be used. They are formed by a sputtering method and patterned by using well-known photolithography into each electrode.

The organic EL layer 503 is formed as a laminate structure by continuously forming a hole transport layer, light emission layer, electron transport layer, and electron injection layer successively. The hole transport material forming the hole transport layer or the electron transport material forming the electron transport layer is not restricted and can be selected from various materials as shown below. Further, a method of separating the electron transport layer and the light emission layer to constitute them from different materials or incorporating a dopant together in the light emission layer for controlling the light emission intensity and color tone can also be adopted.

As the hole transport materials, aromatic mono-, di-, tri-, and tetra-, polyamine compounds represented by diphenyl naphthyl diamine (α-NPD), their derivatives, their polymerization products, as well as hydrazone, silanamine, enamine, quinacridone, phosphamine, phenanthridine, benzylphenyl compounds, styryl compounds, etc. can be used. Further, it is also possible to use polymeric materials such as polyvinylcarbazole, polycarbonate, polysilane, polyamide, polyaniline, polyphosphazen, and polymethacrylate containing aromatic amine for the hole transport materials.

Examples of electron transport materials include 8-hydroxyquinoline aluminum complexes or their derivatives represented by tris(8-quinolinol)-aluminum complex derivatives, derivatives of cyclopentadiene, perynone, oxadiazole, bisstilbene, distilpyrazine, pyridine, naphyridine, triazine, etc. nitrile or p-phenylene compounds, complexes of rare-earth elements, etc.

Further, the organic EL layer can be also formed out of a material having a function separated from the hole injection layer, the hole transport layer, the emission layer, the electron transport layer, and the electron injection layer.

Finally, the organic EL display device is completed by being connected with a drive SIL for driving the display pixel circuit, and peripheral circuits mounting ISI such as for control and power source (details are shown in FIG. 9).

While the manufacturing method has been described as a low molecular weight type organic EL display device of forming the organic EL layers by vapor deposition but the invention is applicable also to an organic EL display device referred to as a polymeric type and the difference of the material of the organic EL layer does not impair the effect of the invention.

Then, organic EL display device according to examples of the invention are to be described specifically together with organic EL display devices prepared for comparison (Comparative examples).

### EXAMPLE 1

In this example, the organic EL display device of the constitution described for the cross sectional view of FIG. 1 was manufactured under the following conditions. In FIG. 1, the organic EL display circuit 102 formed above the substrate 101 has a shape adaptive to the passive type organic EL display device (hereinafter referred to as a passive type organic EL display circuit). A transparent porous film comprising the silicon dioxide particle condensation material (moisture absorption film) 105 was formed by spin coating a solution material of an ethanol solvent containing a colloid of silicon dioxide particles (silica particles) having a particle size within a range from 60 to 100 nm over the entire surface of a planar glass substrate 106 as a sealing substrate. The solution material coated on the planar glass substrate was heated in a nitrogen atmosphere at 100° C. for 10 min and then heated at 150° C. for 10 min to agglomerate the silicon dioxide particles, to form a porous film (moisture absorption film) 105. Agglomeration of the silicon dioxide particles in the porous film 105 is optimized by setting the particle size within the range described above.

Then, a dewatering treatment under heating was applied to the porous film (moisture absorption film) 105 in a dry atmosphere at 250° C. for 30 min and then the following steps were conducted in a circumstance kept as a dry atmosphere. As a sealing material a photocurable resin (sealing material for flat panel display (FPD), produced by Three Bond Co., Ltd., Tokyo, Japan) was coated only at the periphery of the substrate 101 by a dispenser, the substrate 1 and the planar glass substrate 106 were stacked and irradiation of light (UV light) was conducted to the sealing material 103 from the side of the planar glass substrate to harden the sealing material and a space 104 between the substrate 101 and the planar glass substrate 106 is sealed with the sealing material 103 to manufacture an organic EL display device.

### COMPARATIVE EXAMPLE 1

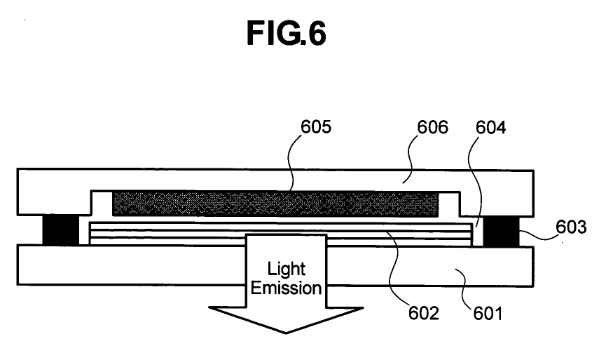

FIG. 6 is a cross sectional view of an organic El display device for explaining a comparative example in the invention. Comparative Example 1 was manufactured under the following conditions. A sheet drying agent (for organic electroluminescent display, produced by Japan Gore-Tex inc. (JGI), Tokyo, Japan) was bonded as a hygroscopic material 605 to a glass substrate 606 having an excavated shape instead of the planar glass substrate 106 in Example 1 to form a sealing substrate and an organic El display device was manufactured under the same conditions as in Example 1. The space volume of the sealing space 604 increased by 50 times or more compared with that of Example 1 since the excavated glass substrate is used.

Organic EL display devices manufactured in Example 1 and Comparative Example 1 were kept at 85° C. for 500 hours and a reliability test was conducted for the display device. There was no difference between the two display devices and deterioration of the organic EL layer was not observed.

As described above, the organic EL display device of Example 1 showed no problem in view of the reliability when compared with the existent organic EL display device, the sealing step could be simplified compared with the existent case and an organic EL display device at a reduced cost and of high reliability could be obtained.

### EXAMPLE 2

A substrate 201 having an organic EL display circuit 202 shown in FIG. 2 was manufactured. The organic El display circuit 202 was constituted as a passive type organic EL display circuit. The same colloidal solution of silicon dioxide particles as in Example 1 was spin-coated over the entire surface of the planar glass substrate 206 and the coating was heated in a nitrogen atmosphere at 100° C. for 10 min and then at 150° C. for 10 min to form a porous film of the silicon dioxide particle condensation material (moisture absorption film) 205. Then, a dewatering treatment was applied under heating at 250° C. for 30 min to the porous film (moisture absorption film) 205 and, subsequently, the following steps were conducted in a circumstance kept as a dry atmosphere.

As the sealing material 203, the same photocurable resin as in Example 1 was coated only at the periphery of a substrate 201 by a dispenser, the substrate 201 and the planar glass substrate 206 were stacked to each other and light irradiation (UV light) was applied to the sealing material 203 on the side of the planar glass substrate to cure the sealing material 203, and a space 204 between the substrate 201 and the planar glass substrate 206 was sealed with the sealing material 203 to manufacture an organic EL display device.

### EXAMPLE 3

A substrate 301 having an organic EL display circuit 302 shown in FIG. 3 was manufactured. The organic El display circuit 202 was constituted as a passive type organic EL display circuit. The same colloidal solution of silicon dioxide particles as in Example 1 was spin-coated over the entire surface of the planar glass substrate 306 and the coating was heated in a nitrogen atmosphere at 100° C. for 10 min and then at 150° C. for 10 min to form a porous film of the silicon dioxide particle condensation material (moisture absorption film) 305. Then, a dewatering treatment was applied under heating at 250° C. for 30 min to the porous film (moisture absorption film) 205 and, subsequently, the following steps were conducted in a circumstance kept as a dry atmosphere.

As the sealing material 303, the same photocurable resin as in Example 1 was coated only at the periphery of the substrate 301 by a dispenser, the substrate 301 and the planar glass substrate 306 were stacked to each other and light irradiation (UV light) was applied to the sealing material 303 on the side of the planar glass substrate to cure the sealing material 303 and a space 304 between the substrate 301 and the planar glass substrate 306 was sealed with the sealing material 303 to manufacture an organic EL display device.

### COMPARATIVE EXAMPLE 2

In Examples 2 and 3, a not-transparent sheet drying agent as used in Comparative Example 1 could not be used. For comparison with Examples 2 and 3, a chemical adsorption type transparent drying agent instead of the not-transparent sheet drying agent was used to prepare a similar organic EL display device with that in Comparative Example 1. Since the chemical adsorption type drying agent adsorbs moisture by chemical reaction, it should not exude to the outer periphery of the sealing material. Therefore, it is necessary to form the material by coating under a dry atmospheric circumstance using a dispenser in a frame such as an excavated sealing substrate.

A reliability test was conducted for the display device while maintaining the organic EL display devices manufactured in Examples 2 and 3 and Comparative Example 2 at 85° C. for 500 hours, and there was no difference for the three display devices and deterioration of the organic EL layer was not observed. As described above, the organic EL display device of the invention manufactured in Examples 2 and 3 showed no problems in view of the reliability and the sealing step was simplified when compared with the existent organic EL display device and organic EL display devices of high reliability could be obtained at a reduced cost.

### EXAMPLE 4

A substrate 401 having an organic EL display circuit 402 having an organic EL layer emitting white light shown in FIG. 4 was manufactured. The organic EL display circuit 402 was constituted as a passive type organic EL display circuit. After forming a coating of a pigment-dispersed red resist solution on a transparent planar glass substrate 406 and exposing a portion thereof by using well-known photolithography, it was developed and heat-cured to obtain a desired red pattern. Then, a coating of a pigment-dispersed green resist solution was formed and, after photoexposing a portion thereof by well-known photolithography, it was developed and heat-cured to obtain a desired green pattern. Then, coating of a pigment-dispersed blue resist solution was formed and, after photoexposing a portion thereof by well-known photolithography, it was developed and heat-cured to obtain a desired blue pattern. By the steps described above, a color filter layer 407 comprising pigment-dispersed red, green, and blue patterns (for example, a plurality of juxtaposed resin layers) was prepared on the principal surface of the planar glass substrate 406.

Then, the same colloidal solution of the silicon dioxide particles as in Example 1 was spin-coated over the entire surface of the planar glass substrate 406, the coating was heated in a nitrogen atmosphere at 100° C. for 10 min and then at 150° C. for 10 min to form a porous film of the silicon dioxide particle condensation material (moisture absorption film) 405 covering the color filter 407 (for example, a plurality of resin layers showing different colors). Then, the porous film (moisture absorption film) was applied with a dehydrating treatment under heating in a dry atmosphere at 220° C. for 30 min and then the following steps were conducted in a circumstance kept as a dry atmosphere.

For the sealing material 403, the same photocurable resin as in Example 1 was used and coated at the periphery of the substrate 401 by a dispenser, the substrate 401 and the planar glass substrate 406 were stacked to each other and photo irradiation (UV light) was conducted to the sealing material 403 on the side of the planar glass substrate to cure the sealing material 403, and a space between the substrate 401 and the planar glass substrate 406 was sealed with the sealing material 403 to manufacture an organic EL display device. As described above, the white light emission from the organic EL layer was spectralized by transmission through the color filter layer comprising pigment-dispersed red, green and blue patterns to obtain an organic EL display device capable of color image display.

In Example 4, the not-transparent sheet drying agent as used in Comparative Example 1 could not be used. Further, since the concaved shape for coating the chemical adsorption type drying agent as in Comparative Example 2 could not be prepared on the side of the sealing substrate, it was not easy to form the drying agent in the sealing substrate. Accordingly, the organic EL display device of the invention manufactured in Example 4 could provide the structure that could not be manufactured easily in the existent organic EL display device extremely simply and conveniently, and a highly reliable organic EL display device could be attained at a reduced cost.

### EXAMPLE 5

In FIG. 5, an ITO film was formed on the principal surface of the transparent substrate 501 by a sputtering method, and the ITO film was patterned by using well-known photolithography to form an ITO electrode (lower electrode) 502. Then, the same colloidal solution of silicon dioxide particles as used in Example 1 was spin-coated over the entire surface of substrate 406, and the coating was heated in a nitrogen atmosphere at 100° C. for 10 min and then at 150° C. for 10 min to agglomerate the silicon dioxide particles in the coating to form a porous film. A resist coating was formed over the porous film comprising the silicon dioxide particle condensation material by using well-known photolithography and, by way of photoexposure, development, and heat-curing, a resist pattern having a desired shape was formed on the porous film.

The porous film of the silicon dioxide particle condensation material was patterned by a dry etching method with an SF₆ gas by using the resist pattern as a mask, the resist mask pattern was removed to form a porous pillar 505 comprising the silicon dioxide particle condensation material for use in pixel partition wall exposing the ITO electrode (lower electrode) 502. Then, a dewatering treatment under heating was applied to the porous pillar 505 in a dry atmosphere at 250° C. for 30 min and then the following steps were conducted in a circumstance kept as a dry atmosphere.

An oxygen plasma treatment was applied to the surface of the ITO electrode 502 as a transparent anode electrode in a vacuum vessel for 2 min, then a hole transport layer, a light emission layer, an electron transport layer, and an electron injection layer were successively formed continuously as an organic EL layer 503 to the upper surface of the ITO electrode 502 and then an upper electrode 504 was formed on the organic EL layer 503 (lamination structure).

As the hole transport layer, diphenyl naphthyl diamine was vapor deposited under vacuum. In this step, a vapor deposition mask was used for vapor depositing the material only for the pixel portion (upper surface of ITO electrode 502), and the temperature of the substrate 501 was set to a room temperature and the vacuum degree in the vapor deposition atmosphere was set to 10⁻⁴ Pa respectively. Heating of the vacuum deposition boat for supplying the material was controlled such that the vapor deposition rate of the material to the pixel portion of the substrate 501 was from 0.1 to 1 nm/s, and the thickness of the vapor deposition film was set to 50 nm.

For the electron transport layer and light emission layer, a tris(8-quinolinol) aluminum complex derivative, and a dopant material corresponding to the light emission of three RGB primary colors were vapor deposited on every pixel. The temperature of the substrate 501 was set to a room temperature and the vacuum degree in the vapor deposition atmosphere was set to 10⁻⁴ Pa, respectively. The heating for the vapor deposition boat for supplying the material was controlled such that the vapor deposition rate of the material for the electron transport layer and light emission layer to the pixel portion of the substrate 501 was from 0.1 to 1 nm/s, and the thickness of the vapor deposition film was set to 70 nm.

As an electron injection layer, LiF was vapor deposited. The temperature of the substrate 501 was set to a room temperature and the vacuum degree of the vapor deposition atmosphere thereof was set to 10⁻⁴ Pa respectively. Heating for the vapor deposition boat for supplying the material was controlled such that the vapor deposition rate of the material for the electron injection layer was from 0.1 to 1 nm/s, and the thickness of the vapor deposition film was set to 0.5 nm. For the upper electrode 504, an Al film was vapor deposited by using a vapor deposition mask for vapor depositing the material therefor (Al) over the entire surface of a pixel area (refer to the display circuit region 140 in FIG. 9 described above) excluding the periphery for the principal surface of the substrate 501. The temperature of the substrate 501 was set to a room temperature and the vacuum degree of the vapor deposition atmosphere thereof was set to 10⁻⁴ Pa, respectively. Heating for the boat for supplying the material (Al) of the upper electrode 504 was controlled such that the vapor deposition rate of the material was from 0.1 to 1 nm/s, and the thickness of the vapor deposition film was set to 150 nm.

On the other hand, the same colloidal solution of the silicon dioxide particles as in Example 1 was coated over the entire principal surface of the planar glass substrate 509, and the coating was heated in a nitrogen atmosphere at 100° C. for 10 min and then at 150° C. for 10 min to form a porous film (moisture adsorption film) 508 comprising the silicon dioxide particle condensation material. Then, a dewatering treatment was applied to the porous film (moisture adsorption film) 508 under heating in a dry atmosphere at 250° C. for 30 min and, subsequently, the following steps were conducted in a circumstance kept as a dry atmosphere.

As the sealing material 507, the same photocurable resin as in Example 1 was coated only to the periphery of the substrate 501, the substrate 501 and the planer glass substrate 509 were stacked to each other, light irradiation (UV light) was conducted from the side of the planar glass substrate to the sealing material 507 to harden the sealing material 503, and the space 506 between the substrate 501 and the planar glass substrate 509 was sealed by the sealing material 507, to manufacture an organic EL display device.

In Example 5, a pixel partition wall pillar in the existent passive type organic EL display device was formed as a porous film of the silicon dioxide particle condensation material also having the moisture adsorptive function. In the existent passive type organic EL display device, moisture intrudes from the periphery of the base of the pillar (dielectric partition wall) into the organic EL layer to result in deterioration of the organic EL layer (edge growth, dark spot). On the contrary, in the structure of Example 5, intrusion of moisture into the organic EL layer was suppressed by the adsorption of the moisture to the pillars, and a highly reliable organic EL display device having a structure not present in the existent organic EL display device was obtained.

### EXAMPLE 6

The organic EL display circuit 102 in Example 1 was manufactured as an active type display circuit comprising a low temperature polysilicon thin film transistor, and an active type organic EL display device having the moisture adsorption film 105 formed by the same steps as those in Example 1 was manufactured. The outline of the active type display circuit is illustrated with reference to FIG. 9, and the cross section of the pixel structure having the same is illustrated with reference to FIG. 8.

### EXAMPLE 7

The organic EL display circuit 202 in Example 2 was manufactured as an active type display circuit comprising a low temperature polysilicon thin film transistor, and an active type organic EL display device having the moisture adsorption film 205 formed by the same steps as those in Example 2 was manufactured.

### EXAMPLE 8

The organic EL display circuit 302 in Example 3 was manufactured as an active type display circuit comprising a low temperature polysilicon thin film transistor, and an active type organic EL display device having the moisture adsorption film 305 formed by the same steps as those in Example 3 was manufactured.

### EXAMPLE 9

The organic EL display circuit 402 in Example 4 was manufactured as an active type display circuit comprising a low temperature polysilicon thin film transistor, and an active type organic EL display device having the moisture adsorption film 405 formed by the same steps as those in Example 4 was manufactured.

### EXAMPLE 10

A porous film of the silicon dioxide particle condensation material forming the moisture absorption film 105 in Example 1 was formed by using a solution material in which a colloid of the silicon dioxide particle (silica particle) with the particle size in a range from 40 to 60 nm was dispersed in an ethanol solvent, and an organic EL display device formed by the same steps as those in Example 1 was manufactured. In this example, the particle size of the silicon dioxide particles was restricted within the range described above, and the silicon dioxide particles in the porous film (moisture absorption film) 105 were agglomerated and the optical characteristics thereof were optimized.

### EXAMPLE 11

An organic EL display device was manufactured by the steps identical with those in Example 2 in which the silicon dioxide particle condensation material forming the moisture adsorption film 205 in Example 2 was prepared by using a solution material containing a colloid of silicon dioxide particles with the particle size in a range from 40 to 60 nm dispersed in an ethanol solvent.

### EXAMPLE 12

An organic EL display device was manufactured by the steps identical with those in Example 3 in which the silicon dioxide particle condensation material forming the moisture adsorption film 305 in Example 3 was prepared by using a solution material containing a colloid of silicon dioxide particles with the particle size in a range from 40 to 60 nm dispersed in an ethanol solvent.

### EXAMPLE 13

An organic EL display device was manufactured by the steps identical with those in Example 4 in which the silicon dioxide particle condensation material forming the moisture adsorption film 405 in Example 4 was prepared by using a solution material containing a colloid of silicon dioxide particles with the particle size in a range from 40 to 60 nm dispersed in an ethanol solvent.

### EXAMPLE 14

An organic EL display device was manufactured by the steps identical with those in Example 5 in which the silicon dioxide particle condensation material forming the moisture adsorption film 508 and pillar 505 in Example 5 was prepared by using a solution material containing a colloid of silicon dioxide particles with the particle size in a range from 40 to 60 nm dispersed in an ethanol solvent.

### EXAMPLE 15

An organic EL display device was manufactured by the steps identical with those in Example 6 in which the silicon dioxide particle condensation material forming the moisture adsorption film 105 in Example 6 was prepared by using a solution material containing a colloid of silicon dioxide particles with the particle size in a range from 40 to 60 nm dispersed in an ethanol solvent.

### EXAMPLE 16

An organic EL display device was manufactured by the steps identical with those in Example 7 in which the silicon dioxide particle condensation material forming the moisture adsorption film 205 in Example 7 was prepared by using a solution material containing a colloid of silicon dioxide particles with the particle size in a range from 40 to 60 nm dispersed in an ethanol solvent.

### EXAMPLE 17

An organic EL display device was manufactured by the steps identical with those in Example 8 in which the silicon dioxide particle condensation material forming the moisture adsorption film 305 in Example 8 was prepared by using a solution material containing a colloid of silicon dioxide particles with the particle size in a range from 40 to 60 nm dispersed in an ethanol solvent.

### EXAMPLE 18

An organic EL display device was manufactured by the steps identical with those in Example 9 in which the silicon dioxide particle condensation material forming the moisture adsorption film 405 in Example 9 was prepared by using a solution material containing a colloid of silicon dioxide particles with the particle size in a range from 40 to 60 nm dispersed in an ethanol solvent.

### EXAMPLE 19

An organic EL display device was manufactured by the steps identical with those in Example 1 in which the silicon dioxide particle condensation material forming the moisture adsorption film 105 in Example 1 was prepared by using a solution material containing a colloid of silicon dioxide particles (silica particle) with the particle size in a range from 2 to 40 nm dispersed in an ethanol solvent. In this example, the particle size of the silicon dioxide particle is restricted within the range described above, and agglomeration of the silicon dioxide particles in the porous film (moisture adsorption film) 105, the adsorbing efficiency of molecules of water, and optimization of the optical characteristics of the porous film 105 were studied.

### EXAMPLE 20

An organic EL display device was manufactured by the steps identical with those in Example 2 in which the silicon dioxide particle condensation material forming the moisture adsorption film 205 in Example 2 was prepared by using a solution material containing a colloid of silicon dioxide particles with the particle size in a range from 2 to 40 nm dispersed in an ethanol solvent.

### EXAMPLE 21

An organic EL display device was manufactured by the steps identical with those in Example 3 in which the silicon dioxide particle condensation material forming the moisture adsorption film 305 in Example 3 was prepared by using a solution material containing a colloid of silicon dioxide particles with the particle size in a range from 2 to 40 nm dispersed in an ethanol solvent.

### EXAMPLE 22

An organic EL display device was manufactured by the steps identical with those in Example 4 in which the silicon dioxide particle condensation material forming the moisture adsorption film 405 in Example 4 was prepared by using a solution material containing a colloid of silicon dioxide particles with the particle size in a range from 2 to 40 nm dispersed in an ethanol solvent.

### EXAMPLE 23

An organic EL display device was manufactured by the steps identical with those in Example 5 in which the silicon dioxide particle condensation material forming the moisture adsorption film 508 and pillar 505 in Example 5 was prepared by using a solution material containing a colloid of silicon dioxide particles with the particle size in a range from 2 to 40 nm dispersed in an ethanol solvent.

### EXAMPLE 24

An organic EL display device was manufactured by the steps identical with those in Example 6 in which the silicon dioxide particle condensation material forming the moisture adsorption film 105 in Example 6 was prepared by using a solution material containing a colloid of silicon dioxide particles with the particle size in a range from 2 to 40 nm dispersed in an ethanol solvent.

### EXAMPLE 25

An organic EL display device was manufactured by the steps identical with those in Example 7 in which the silicon dioxide particle condensation material forming the moisture adsorption film 205 in Example 7 was prepared by using a solution material containing a colloid of silicon dioxide particles with the particle size in a range from 2 to 40 nm dispersed in an ethanol solvent.

### EXAMPLE 26

An organic EL display device was manufactured by the steps identical with those in Example 8 in which the silicon dioxide particle condensation material forming the moisture adsorption film 305 in Example 8 was prepared by using a solution material containing a colloid of silicon dioxide particles with the particle size in a range from 2 to 40 nm dispersed in an ethanol solvent.

### EXAMPLE 27

An organic EL display device was manufactured by the steps identical with those in Example 9 in which the silicon dioxide particle condensation material forming the moisture adsorption film 405 in Example 9 was prepared by using a solution material containing a colloid of silicon dioxide particles with the particle size in a range from 2 to 40 nm dispersed in an ethanol solvent.

For each of the organic EL display devices manufactured in the steps described above, a reliability test was conducted under the same conditions as in Example 1 and the results thereof were compared with those of the organic EL display device of Comparative Example 1. As a result, there was no difference for the display performance between the organic EL display device of each of the examples and the organic EL display device of Comparative Example 1 and deterioration of the organic EL layer was not observed in the organic EL display device for each of the examples.

### EXAMPLE 28

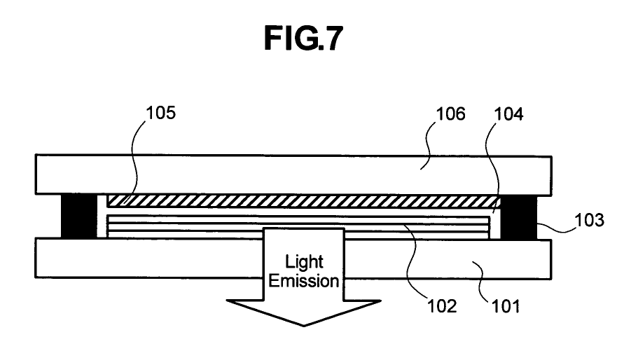

FIG. 7 is a cross sectional view of an organic EL display device for explaining Example 28 of the invention. In Example 28, the organic EL display device having the cross sectional structure shown in FIG. 7 under the following conditions. In the substrate 101 (organic EL display circuitry substrate) in FIG. 7, a passive type organic EL display circuit 102 was formed which was shield by a planar sealing substrate 106 made of a glass plate by using a sealing material 103. A solution material in which a colloid of silicon dioxide particles (silica particles) having the particle size within a range from 60 to 100 nm was dispersed in an alcohol or ketone organic solvent was coated to the inner surface of the planar sealing substrate 106 (principal surface opposed to the substrate 101), and then the coating of the solution material was removed from the periphery of the planar sealing substrate 106 by spraying an alcohol solvent.

Then, the coating of the solution material left at the planar sealing substrate 106 (near the center thereof) was heated in a nitrogen atmosphere at 100° C. for 10 min and then at 150° C. for 10 min respectively to be transformed into a porous film (moisture absorption film) 105 comprising the condensation material of silicon dioxide particles contained therein. The porous film 105 was further applied with a dewatering treatment under heating in a dry atmosphere at 250° C. for 30 min and then it was sealed between the substrate 101 and the sealing substrate 106 by the step to be described below in a circumstance kept as the dry atmosphere.

As the sealing material 103, a photo-curable resin (a sealing material for use in FPD manufactured by Three Bond Co. Ltd.) was coated only at the periphery of the substrate 101 by a dispenser, and light irradiation (UV-light) was conducted to the sealing material 103 on the side of the planer sealing substrate 106 in a state where the substrate 101 and the planar sealing substrate 106 were stacked to each other. The porous film 105 was sealed together with the organic EL display circuit 103 by the hardening of the sealing material 103 between the substrate 101 and the sealing substrate 106 to complete the organic EL display device of this example.

A reliability test was conducted on the organic EL display device manufactured by the steps described above under the same conditions as in Example 1 and the results thereof were compared with those of the organic EL display device of Comparative Example 1. There was no difference for the display performance between the organic EL display device of this example and the organic EL display device of Comparative Example 1, and deterioration of the organic EL layer was not observed in the organic EL display device of this example, as a result of the experiment.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. An organic electroluminescence display device comprising:
a display circuitry substrate having a display circuit formed by laminating a lower electrode, an organic electroluminescence layer, and an upper electrode successively on a principal surface of the display circuitry substrate, the display circuit causes the organic electroluminescence layer to emit light by a current flowing between the lower electrode and the upper electrode,
a light transmitting planar sealing substrate stacked to be opposed to the principal surface of the display circuitry substrate, and
a sealing material for bonding the principal surface of the display circuitry substrate and the planar sealing substrate at each periphery thereof and sealing the display circuit between the principal surface of the display circuitry substrate and the planar sealing substrate, wherein
a porous moisture adsorption film composed of a silicon dioxide particle condensation material is formed on a surface of the planar sealing substrate opposite to the display circuitry substrate.

2. The organic electroluminescence display device according to claim 1, wherein
the display circuitry substrate and the lower electrode have light transmittance and the light emission from the organic electroluminescence layer is emitted from the display circuitry substrate.

3. The organic electroluminescence display device according to claim 1, wherein
the upper electrode and the planar sealing substrate have light transmittance, the water absorption film is transparent to a light in a visible region, and the light emission from the organic electroluminescence layer is emitted through the moisture absorption film from the planar sealing substrate.

4. The organic electroluminescence display device according to claim 1, wherein
the display circuitry substrate, the lower electrode, the upper electrode, and the planar sealing substrate have light transmittance, and the light emission from the organic electroluminescence layer is emitted from both of the display circuitry substrate and the planar sealing substrate.

5. The organic electroluminescence display device according to claim 1, wherein
a plurality of the active type display circuits each having a thin film transistor circuit are arranged in a 2-dimensional manner on the principal surface of the display circuitry substrate.

6. The organic electroluminescence display device according to claim 1, wherein
the moisture adsorption film is formed over an entire area of the surface of the planar sealing substrate opposed to the principal surface of the display circuitry substrate, and the entire area of the surface of the planar sealing substrate includes the outer periphery of the sealing portion.

7. The organic electroluminescence display device according to claim 1, wherein
the moisture adsorption film is formed inside an area of the surface of the planar sealing substrate opposed to the principal surface of the display circuitry substrate, and the area is surrounded by the sealing material in the surface of the planar sealing substrate.

8. The organic electroluminescence display device according to claim 1, wherein
a plurality of the display circuits where the organic electroluminescence layer emits a light of red color, a plurality of the display circuits where the organic electroluminescence layer emits a light of green color, and a plurality of the display circuits where the organic electroluminescence layer emits a light of blue color are arranged, respectively, on the principal surface of the display circuitry substrate, and color images are displayed by the combination of light emission from the display circuits.

9. An organic electroluminescence display device comprising:
a display circuitry substrate where a plurality of pixels each having a display circuit formed by laminating a lower electrode, an organic electroluminescence layer, and a light transmitting upper electrode successively are formed on a principal surface,
a light transmitting planar sealing substrate which is stacked being opposed to the principal surface of the display circuitry substrate, and
a sealing material for bonding the principal surface of the display circuitry substrate and the planar sealing substrate along each periphery thereof and sealing the display circuit between the principal surface of the display circuitry substrate and the planar sealing substrate, wherein
the light emission from the organic electroluminescence layer is emitted out from the planar sealing substrate, and wherein
a plurality of color filter layers for coloring the light emission from the organic electroluminescence layer disposed to one of the plurality of pixels to red color, green color, or blue color respectively, and a porous film comprising a silicon dioxide particle condensation material covering the entire color filter layer are formed to the planar sealing substrate on the surface opposed to the principal surface of the display circuitry substrate.

10. The organic electroluminescence display device according to claim 9, wherein
the light emission from the organic electroluminescence layer disposed to each of the plurality of pixels is white and the light emission is transmitted to each of the color filter layers thereby displaying color images.

11. The organic electroluminescence display device according to claim 9, wherein
each of the plurality of pixels has the active type display circuit having a thin film transistor circuit.

12. The organic electroluminescence display device according to claim 9, wherein
the porous film is formed to the planar sealing substrate over the entire region including the outer periphery of the region surrounded by the sealing material at the surface opposed to the principal surface of the display circuitry substrate.

13. The organic electroluminescence display device according to claim 9, wherein
the porous film is formed to the planar sealing substrate in the inside of a region surrounded by the sealing material on the surface opposed to the principal surface of the display circuitry substrate.

14. The organic electroluminescence display device according to claim 9, wherein
a pixel partition wall comprising the silicon dioxide particle condensation material is formed between adjacent pair of plurality of pixels on the principal surface of the display circuitry substrate.

15. The organic electroluminescence display device according to claim 9, wherein
the particle size of the silicon dioxide particle is within a range of 2 nm or more and 500 nm or less.

16. A method of manufacturing an organic electroluminescence display device including a display circuitry substrate where a plurality of display circuits each having a pair of electrodes and an organic electroluminescence layer interposed between the pair of electrodes are formed on the principal surface, and a light transmitting planar sealing substrate bonded to the principal surface of the display circuitry substrate by a sealing material and sealing the plurality of display circuits together with the sealing material, the method comprising:
coating a solution containing a colloid of silicon dioxide particles dispersed therein to the planar sealing substrate on a principal surface opposed to the principal surface of the display circuitry substrate, and
heating the coating of the solution formed on the principal surface of the planar sealing substrate, thereby agglomerating the silicon dioxide particles contained therein and forming a porous moisture adsorption film.

17. The method of manufacturing an organic electroluminescence display device according to claim 16, wherein
the porous moisture adsorption film formed by agglomeration of the silicon dioxide particles is heated in a dry atmosphere under the condition at 150° C. or higher and 300° C. or lower and then the planar sealing substrate is bonded to the principal surface of the display circuitry substrate by the sealing material.

18. The method of manufacturing an organic electroluminescence display device according to claim 16, wherein
the porous moisture adsorption film is formed to the principal surface of the planar sealing substrate over the entire region including the outer periphery of the region surrounded by the sealing material.

19. The method of manufacturing an organic electroluminescence display device according to claim 16, wherein
the porous moisture adsorption film is patterned so as to be present only in the inside of the region surrounded by the sealing material on the main surface of the planar sealing substrate.
